(19) United States
(12) Patent Application Publication
(10) Pub. No.: US 2018/0215599 A1
(43) Pub. Date: Aug. 2, 2018

(54) AUTOMATIC BOTTLE OPENER WITH AUTOMATIC SENSING

(71) Applicant: Brookstone Purchasing, Inc., Merrimack, NH (US)

(72) Inventor: Stephen B. MILLS, Atkinson, NH (US)

(21) Appl. No.: 15/882,743

(22) Filed: Jan. 29, 2018

Related U.S. Application Data
(60) Provisional application No. 62/451,334, filed on Jan. 27, 2017.

(51) Int. Cl. B67B 7/04

(52) U.S. Cl. CPC B67B 7/0405

(57) ABSTRACT

An automatic bottle opener includes a motorized auger with automatic sensing for starting and stopping rotation of the auger. In some embodiments, the automatic bottle opener may sense engagement of the bottle opener with a bottle to activate rotation of the motorized auger for engaging and removing the cork and may sense an extracted position of the cork to stop rotation of the motorized auger. Additionally or alternatively, embodiments of the automatic bottle opener may sense a change in position (e.g., a tilted position) of the bottle opener to activate reverse rotation of the motorized auger for ejecting the extracted cork.

### CROSS-REFERENCE TO RELATED APPLICATION

The present application claims the benefit of U.S. Patent Application Ser. No. 62/451,334 filed Jan. 27, 2017, which is fully incorporated herein by reference.

### TECHNICAL FIELD

The present disclosure relates to bottle openers and more particularly, to an automatic bottle opener with automatic sensing.

### BACKGROUND INFORMATION

Motorized wine bottle openers facilitate the removal of a cork from a wine bottle. Existing motorized wine bottle openers generally include a motor driven auger that engages the cork and extracts the cork from the bottle. With existing wine bottle openers, however, the user manually starts and stops the movement of the auger to extract the cork and to eject the cork from the opener.

### SUMMARY

Consistent with one embodiment, an automatic bottle opener includes a housing having an opening configured to receive a cork from a bottle, an auger for engaging the cork, a motor for driving the auger and a cork engaging sleeve slidable relative to the housing from a first position proximate the opening to a second position away from the opening. A start sensor senses an initial movement of the cork engaging sleeve from the first position and causes the motor to start driving the auger in a first rotation direction in response to movement of the cork engaging sleeve. A stop sensor senses the cork engaging sleeve in the second position and causes the motor to stop after the cork has been at least partially extracted.

Consistent with another embodiment, an automatic bottle opener includes a housing having an opening configured to receive a cork from a bottle, an auger for engaging the cork, and a motor for driving the auger, wherein the auger is driven in a first rotation direction to engage the cork and draw the cork into the housing. A position sensor senses a change in position of the housing and activates the motor to drive the auger in a second rotation direction opposite the first rotation direction in response to a sensed change in position.

Consistent with a further embodiment, a method includes: engaging a bottle with one end of an automatic bottle opener; automatically triggering extraction of a cork from the bottle in response to engaging the bottle; and automatically triggering ejection of the cork in response to sensing a position and/or movement of the automatic wine bottle opener.

### BRIEF DESCRIPTION OF THE DRAWINGS

These and other features and advantages will be better understood by reading the following detailed description, taken together with the drawings wherein:

FIGS. 1A and 1B are front and side views, respectively, of an automatic wine bottle opener, consistent with the present disclosure.

FIG. 2 is a front cross-sectional view of the automatic wine bottle opener shown in FIG. 1A.

FIG. 2A is an enlarged view of a cork engaging sleeve and a first or lower limit switch in the automatic wine bottle opener shown in FIG. 2.

FIG. 3 is a side cross-sectional view of the automatic wine bottle opener shown in FIG. 1B.

FIG. 3A is an enlarged view of a second or upper limit switch in the automatic wine bottle opener shown in FIG. 3.

FIG. 4 is a cross-sectional view of the automatic wine bottle opener in a tilted position for cork ejection.

FIG. 4A is an enlarged view of a tilt switch in the automatic wine bottle opener shown in FIG. 4.

FIG. 5A is a cross-sectional view of the tilt switch shown in FIG. 4A.

FIG. 5B is an end view of the tilt switch shown in FIG. 4A.

### DETAILED DESCRIPTION

An automatic bottle opener, consistent with embodiments of the present disclosure, includes a motorized auger with automatic sensing for starting and stopping rotation of the auger. In some embodiments, the automatic bottle opener may sense engagement of the bottle opener with a bottle to activate rotation of the motorized auger for engaging and removing the cork and may sense an extracted position of the cork to stop rotation of the motorized auger. Additionally or alternatively, embodiments of the automatic bottle opener may sense a change in position (e.g., a tilted position) of the bottle opener to activate reverse rotation of the motorized auger for ejecting the extracted cork. Although a particular embodiment is shown and described herein, other embodiments of the automatic bottle opener with automatic sensing are contemplated and within the scope of the present disclosure. The exemplary embodiment is described as an automatic wine bottle opener but the opener may be used to remove a cork from bottles other than wine bottles.

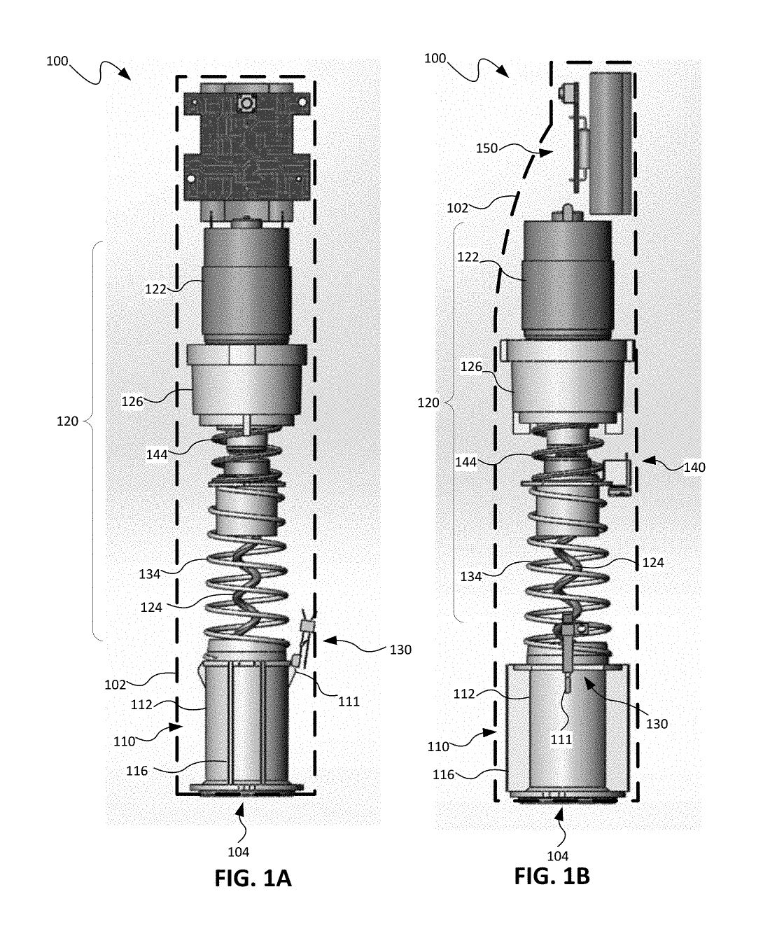

Referring to FIGS. 1A and 1B, an automatic wine bottle opener 100 generally includes a housing 102 (shown schematically in broken lines) enclosing the mechanisms of the bottle opener 100. The housing 102 includes an opening 104 at one end for engaging a bottle and receiving a cork extracted from the bottle. According to this embodiment of the automatic wine bottle opener 100, the housing 102 encloses a cork engaging sleeve 110, a motorized auger mechanism 120, and sensors 130, 140, 150 for activating and controlling the motorized auger mechanism 120, as will be described in greater detail below.

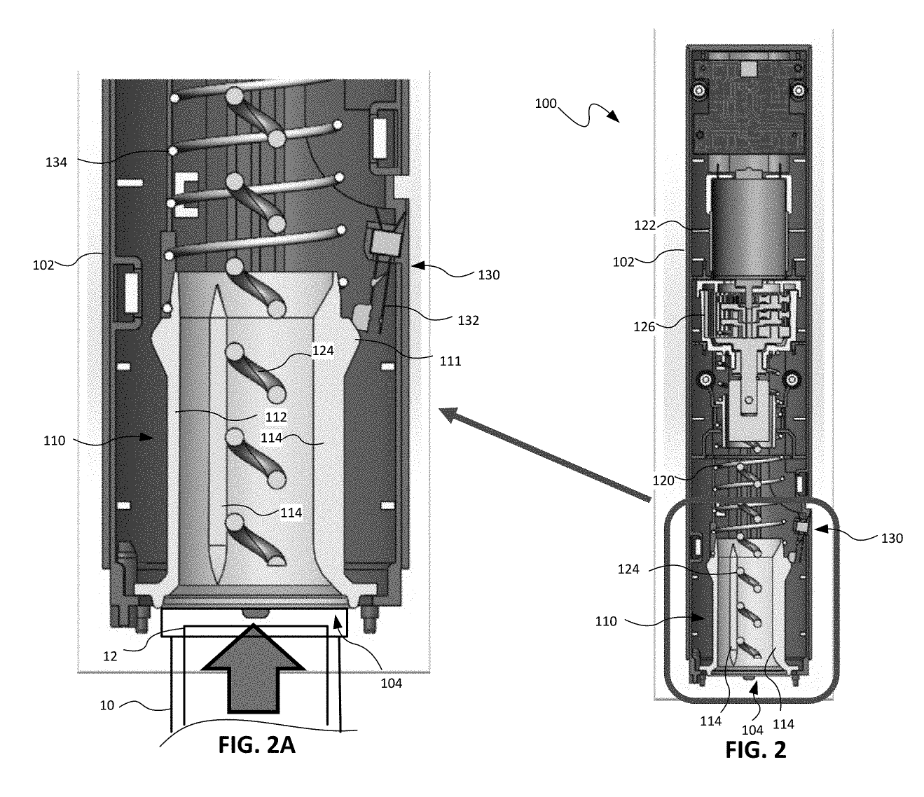

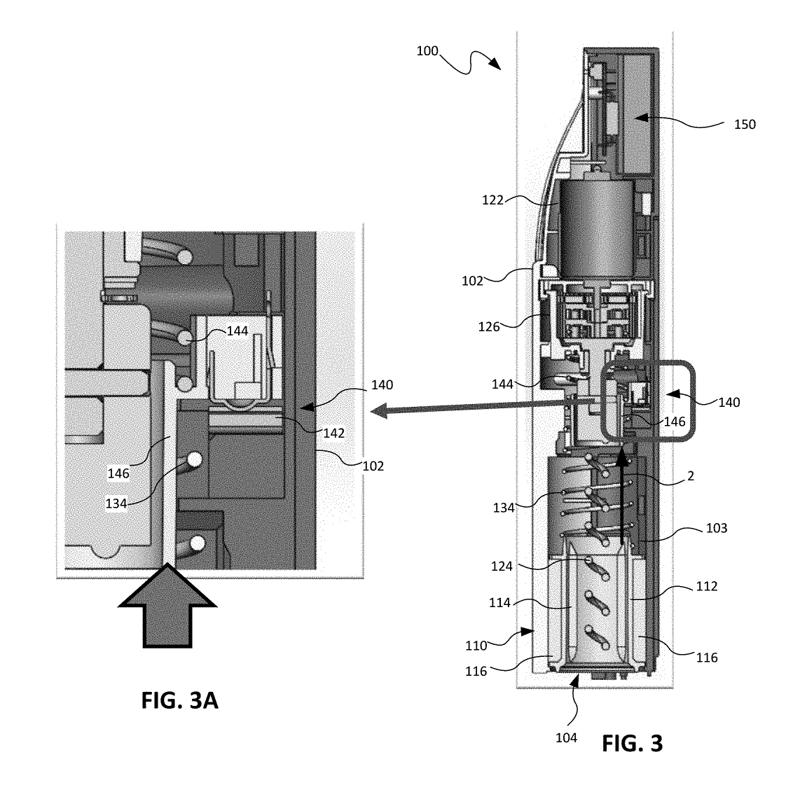

The cork engaging sleeve 110 is configured to engage a cork (not shown) being extracted from a bottle (not shown). The cork engaging sleeve 110 is positioned in a first or initial position at or proximate the opening 104 of the housing 102 and is slidable within the housing 102 away from the opening 104 to a second or extracted position. In the illustrated embodiment, the cork engaging sleeve 110 includes a generally cylindrical body 112 with one or more internal ribs 114 (see FIGS. 2 and 3). The cork may be received at least partially inside the cylindrical body 112 and engaged by the internal ribs 114 to prevent rotation of the cork. This embodiment of the cork engaging sleeve 110 also includes one or more external wings 116 for engaging tracks 103 inside the housing (see FIG. 3). Other configurations and shapes for the cork engaging sleeve are also contemplated and within the scope of the present disclosure.

The motorized auger mechanism 120 generally includes a motor 122 coupled to an auger 124 for rotating the auger 124. In the illustrated embodiment, the motor 120 is coupled to the auger 124 via a gear box 126. The auger 124 is driven by the motor 122 (e.g., in a clockwise direction of rotation) to engage the cork and cause the cork to be extracted from the bottle and at least partially into the cork engaging sleeve 110 and the housing 102. As the cork is extracted from the bottle, the cork engaging sleeve 110 (together with the cork) moves inside the housing 102 away from the opening 104. Reversing the direction of rotation of the motor 122 and the auger 124 (e.g., in a counter clockwise direction) will cause the cork and the cork engaging sleeve 110 to move toward the opening 104 of the housing 102 such that the cork is ejected from the wine opener.

Referring to FIGS. 2 and 2A, a start sensor 130 is located in the housing 102 and is configured to sense initial engagement with a bottle 10 (and/or cork 12) to initiate extraction of a cork 12 in the bottle 10. In the example embodiment, the start sensor 130 includes a first or lower limit switch 132 that engages the cork engaging sleeve 110 at the beginning of travel from the first position. A first (or longer) spring 134, such as a torsion spring, biases the cork engaging sleeve 110 in the first or initial position proximate the opening 104 of the housing such that the lower limit switch 132 is open. Although springs are shown and described herein, any type of biasing element may be used.

When a bottle 10 is inserted into the opening 104 of the housing 102, the bottle 10 pushes upward on the cork engaging sleeve 110 such that the cork engaging sleeve 110 moves against the spring 134 and away from the opening 104. Movement of the cork engagement sleeve causes a projection 111 on the sleeve 110 to activate the lower limit switch 132 by closing the contacts of the limit switch 132, which starts rotation of the motor 122 and the auger 124. The rotating auger 124 pulls the cork 12 into the sleeve 110 and the internal ribs 114 trap the cork 12 (i.e., preventing the cork from rotating). The rotating auger 124 then pulls the cork 12 with the sleeve 110 upwardly against the force of the spring 134 until an automatic stop is initiated, as described below. Although the limit switch 132 is described and shown in the illustrated embodiment, other sensors may be used to sense the initial movement of the cork engaging sleeve 110 or engagement with the bottle 10 including, without limitation, an optical sensor or switch.

Referring to FIGS. 3 and 3A, a stop sensor 140 is located in the housing 102 and configured to sense an extracted position of the cork in the housing 102 to stop cork extraction. In the example embodiment, the stop sensor 140 includes a second or upper limit switch 142 that is engaged by the cork engaging sleeve 110 at the second or extracted position. A second (or shorter) spring 144, such as a torsion spring, biases a housing 146 of the upper limit switch 142 such that the upper limit switch 142 is closed (as shown). In the illustrated embodiment, the housing 146 includes a portion that extends axially toward the sleeve 110 and is configured to engage the sleeve 110 (or some other intermediate structure) when moved to the second or extracted position as shown by arrow 2.

The cork and sleeve 110 will push the upper limit switch housing 146 against the force of the second spring 144 and move the upper limit switch housing 146 upward to activate the upper limit switch 142 by opening the contacts of the upper limit switch 142, which stops rotation of the motor 122 and the auger 124. The cork 12 and sleeve 110 will remain in this position until a cork ejection is initiated, as discussed below. Although the limit switch 142 is described and shown in the illustrated embodiment, other sensors may be used to sense the extracted position of the cork 12 or cork engaging sleeve 110 including, without limitation, an optical sensor or switch. In other embodiments, the motor may be stopped automatically, for example, after an elapsed time.

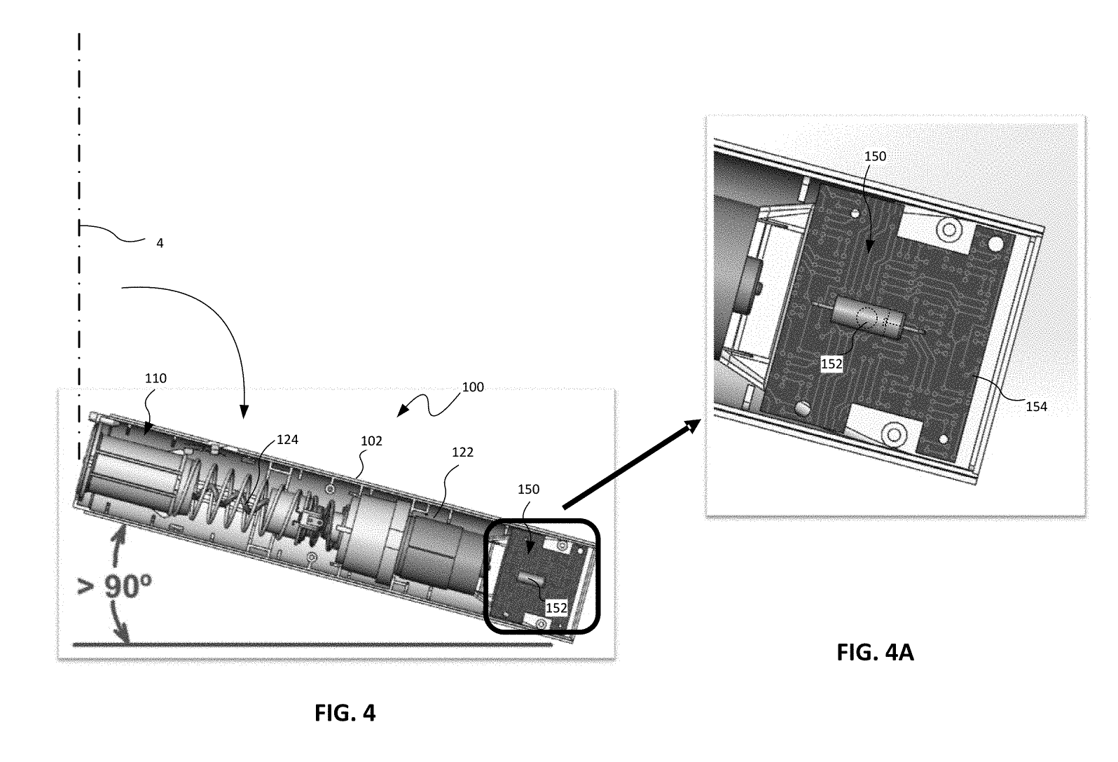

Referring to FIGS. 4 and 4A, a position sensor 150 is located in the housing 102 and configured to sense a position change of the housing 102 (e.g., from a first orientation to a second orientation) to initiate cork ejection. In the example embodiment, the position sensor 150 includes a tilt switch 152 that is activated when the switch 152 (together with the housing 102) is tilted in any direction (e.g., clockwise or counterclockwise) from an upright position (as indicated by dashed line 4) to a tilted position, for example, beyond 90°. Although FIG. 4 shows the cork engaging sleeve 110 in the first or initial position, the cork engaging sleeve would be in the second or extracted position when the bottle opener 100 is tilted for cork extraction. The tilt switch 152 may be mounted on a printed circuit board 154, as shown in FIG. 4A, which may include the circuitry and/or logic for controlling operation of the motor, for example, in response to the activation of the sensors or switches. Other ranges of tilt or detected positions may also be sensed and used to activate the motor to initiate cork ejection.

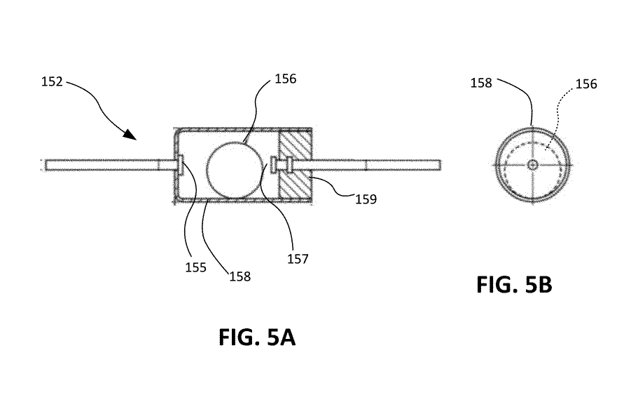

As shown in FIGS. 5A and 5B, the tilt switch 152 may be a roller ball switch including a metal ball 156 inside a conductive metal case 158, a first contact 155 electrically connected to the conductive metal case 158 and a second contact 157 insulated from the conductive metal case 158 by a plastic sleeve 159. In an upright position, the metal ball 156 contacts the first contact 155 and the circuit is not completed. When the metal ball 156 rolls into contact with the second contact 157 (e.g., when tilted), the metal ball 156 completes a circuit between the contacts 155, 157 via the conductive metal case 158. When the tilt switch 152 is activated, the motor 122 is turned on and rotates the auger 124 in an opposite direction (i.e., counter clockwise) to move the cork 12 and the cork engaging sleeve 110 back to the first or initial position, thereby ejecting the cork through the opening 104 of the housing 102. Once the cork is ejected, the cycle may be reset. Although the tilt switch 152 is described and shown in the illustrated embodiment, other sensors may be used to sense a change of position of the housing 102 including without limitation, an inertial measurement unit (IMU) or gyroscopic sensor.

Accordingly, an automatic wine bottle opener, consistent with the present disclosure, provides automatic sensing to start and stop a motorized auger to facilitate extraction of a cork from a bottle and ejection of the cork from the opener.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An automatic bottle opener comprising:
a housing having an opening configured to receive a cork from a bottle;
an auger for engaging the cork;
a motor for driving the auger;
a cork engaging sleeve slidable relative to the housing from a first position proximate the opening to a second position away from the opening;
a start sensor for sensing an initial movement of the cork engaging sleeve from the first position and for causing the motor to start driving the auger in a first rotation direction in response to movement of the cork engaging sleeve; and
a stop sensor for sensing the cork engaging sleeve in the second position and for causing the motor to stop after the cork has been at least partially extracted.

2. The automatic bottle opener of claim 1 wherein the start sensor includes a first limit switch configured to be activated by the cork engaging sleeve when moved from the first position.

3. The automatic bottle opener of claim 1 wherein the stop sensor includes a second limit switch configured to be activated by the cork engaging sleeve when moved to the second position.

4. The automatic bottle opener of claim 1 further comprising a position sensor for sensing a change in position of the housing and activating the motor in response to the change in position to drive the auger in a second rotation direction opposite the first rotation direction.

5. The automatic bottle opener of claim 4 wherein the position sensor is a tilt switch.

6. The automatic bottle opener of claim 5 wherein the tilt switch activates the motor when the housing is tilted more than 90° from a first orientation to a second orientation.

7. The automatic bottle opener of claim 1 wherein the sleeve includes at least one internal rib for engaging the cork.

8. The automatic bottle opener of claim 1 wherein the sleeve has a generally cylindrical body portion.

9. The automatic bottle opener of claim 1 further comprising a biasing element biasing the cork engaging sleeve toward the opening.

10. The automatic bottle opener of claim 1 wherein the start sensor includes a first limit switch and the stop sensor includes a second limit switch.

11. The automatic bottle opener of claim 10 further comprising a first biasing element biasing the cork engaging sleeve toward the opening such that the first limit switch is not closed and a second biasing element biasing the second limit switch such that the second limit switch is closed.

12. The automatic bottle opener of claim 1 further comprising a gear box coupling the motor to the auger.

13. An automatic bottle opener comprising:
a housing having an opening configured to receive a cork from a wine bottle;
an auger for engaging the cork;
a motor for driving the auger, wherein the auger is driven in a first rotation direction to engage the cork and draw the cork into the housing; and
a position sensor for sensing a change in position of the housing and activating the motor to drive the auger in a second rotation direction opposite the first rotation direction in response to a sensed change in position.

14. The automatic bottle opener of claim 13 wherein the position sensor is a tilt switch.

15. The automatic bottle opener of claim 14 wherein the tilt switch activates the motor when the housing is tilted more than 90° from an upright position with the opening facing downward.

16. The automatic bottle opener of claim 13 wherein the sleeve includes at least one internal rib for engaging the cork.

17. The automatic bottle opener of claim 13 further comprising a gear box coupling the motor to the auger.

18. The automatic bottle opener of claim 13 further comprising a start sensor for sensing an initial movement of the cork engaging sleeve from the first position and for causing the motor to start driving the auger in a first rotation direction in response to movement of the cork engaging sleeve.

19. The automatic bottle opener of claim 14 further comprising a start sensor for sensing an initial movement of the cork engaging sleeve from the first position and for causing the motor to start driving the auger in a first rotation direction in response to movement of the cork engaging sleeve.

20. A method comprising:
engaging a bottle with one end of an automatic bottle opener;
automatically triggering extraction of a cork from the bottle in response to engaging the bottle; and
automatically triggering ejection of the cork in response to sensing a position and/or movement of the automatic bottle opener.
